(19) United States
(12) Patent Application Publication
(10) Pub. No.: US 2006/0032071 A1
(43) Pub. Date: Feb. 16, 2006

(54) Sample drying device as well as mass spectrometer and mass spectrometry system therewith

(76) Inventors: Masakazu Baba, Tokyo (JP); Toru Sano, Tokyo (JP); Kazuhiro Uda, Tokyo (JP); Hisao Kawaura, Tokyo (JP); Noriyuki Iguchi, Tokyo (JP); Wataru Hattori, Tokyo (JP); Hiroko Someya, Tokyo (JP); Minoru Asogawa, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/536,767

(22) PCT Filed: Nov. 28, 2003
(86) PCT No.: PCT/JP03/15252

§ 371 Date: May 27, 2005

(30) Foreign Application Priority Data
Nov. 29, 2002 (JP) 2002-349246

(51) Int. Cl. F26B 19/00

(52) U.S. Cl. 34/60; 34/61

(57) ABSTRACT

A channel (103) is formed in a substrate (101) and a drying area (107) comprising a plurality of pillars (105) is formed in one end of the channel (103). A cover (109) is formed over the channel (103), except the area above the drying area (107). When a sample is introduced into the channel (103), it is guided to the drying area (107) by capillary phenomenon. The drying area (107) is heated by a heater (111) to evaporate the solvent for concentrating and drying the solute.

### BACKGROUND OF THE INVENTION

1. Field of the Invention

This invention relates to a sample drying device as well as a mass spectrometer and a mass spectrometry system therewith.

2. Description of the Related Art

Microchips capable of separating a protein or nucleic acid have been intensely investigated and developed (Patent document 1). On such a microchip, there is formed a feature such as a micro-channel for separation by fine processing, whereby an extremely small amount of sample can be introduced into the microchip for separation.

However, in a separation process using a conventional microchip, a component separated is obtained as a solution or dispersion, so that in addition to the microchip, a drying equipment is required for finally providing a dried material.

Analysis of the separated component is generally conducted by mass spectrometry. For example, analysis using a MALDI-TOFMS (Matrix-Assisted Laser Desorption Ionization-Time of Flight Mass Spectrometer) has been suggested as a method for efficiently ionizing a polymer compound for mass spectrometry, and has been applied to proteomics analysis (Patent document 2).

However, when a polymer compound analyzed by mass spectrometry is a biological component such as a protein, a nucleic acid or a polysaccharide, a target component must be isolated from the biological sample in advance. For example, when analyzing a sample comprising multiple components, the sample is purified and then subjected to, for example, two-dimensional electrophoresis for separating individual components; each component is collected from each spot separated; and then the collected component is used to prepare a sample for mass spectrometry. Thus, a separation and a sample preparation processes must be separately conducted, leading to a cumbersome procedure.

In a MALDI-TOFMS, a measurement sample is prepared by blending a sample solution with a matrix solution and adding dropwise the mixture to a metal-plate surface using an appropriate tool such as a micropipette when using an ion-generation promoting material called a matrix. Without a matrix, a sample solution is applied dropwise to a plate in a similar manner.

FIG. 6 illustrates a conventional process for preparing a sample for MALDI-TOFMS measurement. FIGS. 6(a) and 6(b) are a cross-sectional view and a plan view, respectively, showing a sample solution 131 dropped on the surface of a drying substrate 133. As shown in FIG. 6(b), the maximum width of the dropped sample solution 131 is significantly larger than the maximum spot size 135 of a laser beam. As a result, a sample concentration per a unit area is lower and thus, a relatively larger amount of sample is required. The procedure is, therefore, not always a sample preparation process suitable for analyzing a trace amount of sample such as a biological component.

Furthermore, a sheet of drying substrate 133 is used for a plurality of samples in a conventional method. Thus, a drying process is needed for each sample.
Patent Document 1: Japanese Laid-Open Patent Publication No. 2002-207031
Patent Document 2: Japanese Laid-open Patent Publication No. 1998-90226

### SUMMARY OF THE INVENTION

As described above, a drying device has been needed, which can efficiently concentrate and dry a small amount of sample such as a biological sample. In particular, there has been needed a drying device which can efficiently dry a collected sample for mass spectrometry.

In view of the above situation, an objective of this invention is to provide a small sample drying device capable of conveniently and efficiently concentrating and drying a sample, particularly a sample drying device capable of continuously and efficiently drying a component prepared by processing, for example, separation and purification, a biological sample.

Another objective of this invention is to provide a sample drying device for mass spectrometry for efficiently concentrating and drying a sample. A further objective of this invention is to provide a mass spectrometer equipped with a drying device, which is used as a substrate for sample drying and mass spectrometry.

According to this invention, there is provided a sample drying device comprising a channel for a sample flowing in the channel and a sample drying area having an opening communicating with the channel, wherein the sample drying area comprises a fine channel narrower than the channel.

In the sample drying device according to this invention, the sample drying area has a narrower channel and an opening, so that a sample in the channel is quickly guided to the sample drying area by capillary phenomenon. The sample introduced in the sample drying area is quickly dried. As the sample in the sample drying area is dried, a sample solution in the channel is spontaneously and continuously fed to the sample drying area. Thus, the drying device of this invention can be easily operated and can efficiently dry the sample.

In this invention, “fine channel(s)” may be formed as, for example,

(i) voids between multiple protrusions formed in the drying area or between filling members such as beads;

(ii) pores in a porous material disposed in the drying area; or

(iii) concaves formed in the channel wall.

The fine channel preferably communicates with an opening. Thus, a sample drying channel from the channel through the fine channel to the opening can be ensured, so that the sample can be stably dried.

According to this invention, there is also provided a sample drying device comprising a main channel for a sample flowing in the main channel; a plurality of side channels branched from the main channel and a sample drying area communicating with the side channels, wherein the sample drying area has a fine channel narrower than the side channels.

In the sample drying device, the sample drying area is formed in the side chain branched from the main channel, so that the sample can be quickly dried. The side channel can be made narrower than the main channel to ensure guiding a liquid from the main channel to the side channel.

In the device having such a configuration, a sample can be separated, prepared and/or analyzed as appropriate in the main channel, then introduced into the side channel and finally dried in the sample drying area. For example, the sample contains multiple components and the main channel may comprise a separating portion to separate the components. Such a configuration may allow the individual components in the sample to be introduced to a plurality of side channels for preparing dried materials of these components. Thus, a single sample drying device can readily perform multiple processes, for which multiple devices have been employed.

The sample drying device of this invention may comprise a temperature controller for controlling a temperature of the sample drying area. Thus, the sample drying area may be selectively heated to continuously and more efficiently dry the sample and introduce the sample from the channel to the sample drying area during the sample drying.

In the sample drying device of this invention, the sample drying area may comprise a plurality of protrusions separated each other. A void between the protrusions becomes a fine channel, which can ensure introduction of a liquid by capillarity to promote sample drying.

The sample drying device of this invention may have a configuration where the sample drying area may be filled with multiple particles. Such a configuration may be easily formed by filling the channel with the particles from an opening. Thus, a narrower channel may be conveniently formed in the sample drying area.

Alternatively, the sample drying device of this invention may have a configuration where the sample drying area is filled with a porous material. As used herein, the term “porous material” refers to a structure having a fine channel communicating with the outside in both sides.

The sample drying device of this invention may have a configuration where the top of the sample drying area projects from the opening. Thus, a surface area of the side wall of the sample drying area may be further increased to further promote drying.

The sample drying device of this invention may have a configuration where the sample drying area has a lid comprising a fine channel communicating with the outside of the sample drying device. The fine channel in the lid communicating with the outer atmosphere allows a liquid to be guided from the channel to the fine channel in the lid by capillary phenomenon, resulting in efficient drying. Furthermore, since a dried sample is deposited over the fine channel, a surface area of the dried sample can be controlled by adjusting a width of the fine channel in the lid.

The sample drying device of this invention may have a configuration where a metal film is formed on the surface of the drying area. Thus, it may be suitable as an electrode for applying an external force to an ionized sample when being used as a sample holder in a mass spectrometer.

According to this invention, there is also provided a mass spectrometer comprising a sample drying area included in the sample drying device as a sample holder. Since the mass spectrometer of this invention comprises the sample drying area as the sample holder, the sample holder may be used as the sample drying device. Thus, a pretreatment before conducting mass spectrometry, that is, the steps of separation, purification, analysis and collection by drying of components in a sample to be measure, may be continuously conducted in the sample holder, resulting in improved operability. A surface area of the dried sample may be adjusting by the size of the opening over the sample drying area. Thus, the sample may be formed into a shape corresponding to a spot system of a laser beam applied to the sample during mass spectrometry. It can increase a sample concentration in a laser irradiation area, to improve accuracy and sensitivity of the measurement. Even in a small amount of sample, a measurement sample can be, therefore, efficiently prepared and analyzed.

According to this invention, there is also provided a mass spectrometry system comprising separating unit separating components in a biological sample by their molecular sizes and properties; pretreatment unit pretreating the sample components separated by the separating unit including enzymatic digestion; drying unit drying the pretreated sample; and mass spectrometry unit conducting mass spectrometry for the dried sample, wherein the drying unit comprises the above sample drying device. Herein, the biological sample may be obtained by extraction from an organism or by synthesis.

As described above, this invention may provide a small sample drying device for readily and efficiently concentrating or drying a sample, which comprises a sample drying area having an opening and a fine channel narrower than a channel. This invention can also provide a sample drying device for mass spectrometry for efficiently concentrating and drying a sample. This invention further provides a mass spectrometer equipped with a drying device used as a substrate for drying and mass spectrometry of a sample.

### BRIEF DESCRIPTION OF THE DRAWINGS

The above and other objects, features and advantages of the present invention will be more apparent from the following preferred embodiments and the accompanying drawings, in which:

FIG. 1 shows a configuration of a drying device according to an embodiment of this invention;

FIG. 2 shows a configuration of a drying device according to an embodiment of this invention;

FIG. 3 shows a configuration of a drying device according to an embodiment of this invention;

FIG. 4 shows a configuration of a drying device according to an embodiment of this invention;

FIG. 5 schematically shows a configuration of a microchip according to an embodiment of this invention;

FIG. 6 illustrates a conventional method for preparing a sample for mass spectrometry;

FIG. 7 is a process cross-sectional view illustrating a process for manufacturing a drying device according to an embodiment of this invention;

FIG. 8 is a process cross-sectional view illustrating a process for manufacturing a drying device according to an embodiment of this invention;

FIG. 9 is a process cross-sectional view illustrating a process for manufacturing a drying device according to an embodiment of this invention;

FIG. 10 illustrates a drying device according to an embodiment of this invention when it is filled with a liquid;

FIG. 11 illustrates a change in a sample liquid when it is heated by a heater in a drying device according to an embodiment of this invention;

FIG. 12 schematically shows a configuration of a mass spectrometer;

FIG. 13 is a block diagram of a mass spectrometry system comprising a drying device according to an embodiment of this invention;

FIG. 14 shows a configuration of a drying device according to an embodiment of this invention;

FIG. 15 schematically shows a configuration of a chip according to an embodiment of this invention;

FIG. 16 shows a configuration of a pillar disposed in a drying area in a chip according to an embodiment of this invention;

FIG. 17 illustrates DNA exudation in a drying area in a chip according to Example; and

FIG. 18 illustrates a channel outlet in a drying area without a pillar in a chip according to Example.

### DETAILED DESCRIPTION OF THE INVENTION

This invention will be described by means of an exemplary small drying device for readily and efficiently concentrating and drying a sample. The drying device may be used as a sample holder for a mass spectrometer such as a MALDI-TOFMS. In all of the drawings, analogous components are designated by the same symbol, whose description is omitted as appropriate.

### First Embodiment

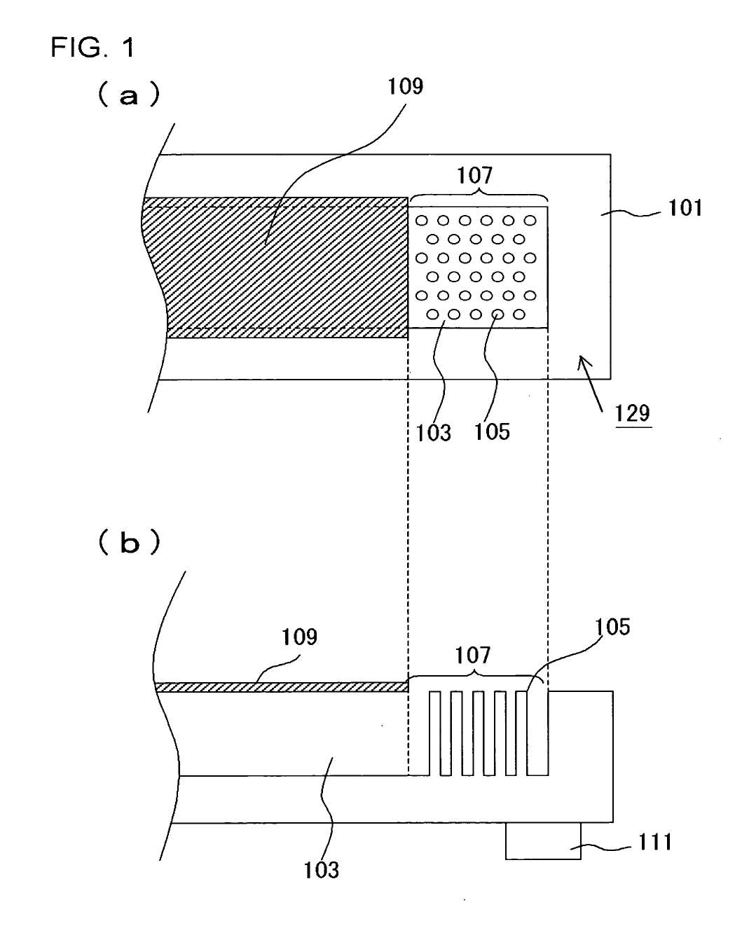

FIG. 1 shows a configuration of a drying device according to this embodiment. FIGS. 1(a) and 1(b) are a plan view and a cross-sectional view of a drying device 129, respectively.

In the drying device 129, substrate 101 comprises a channel 103, which comprises a drying area 107 having a plurality of pillars 105 in one end. The channel 103 is covered by a cover 109, but not covered by the cover 109, that is, opened in the drying area 107. The bottom of the drying area 107 can be temperature-controlled by a heater 111.

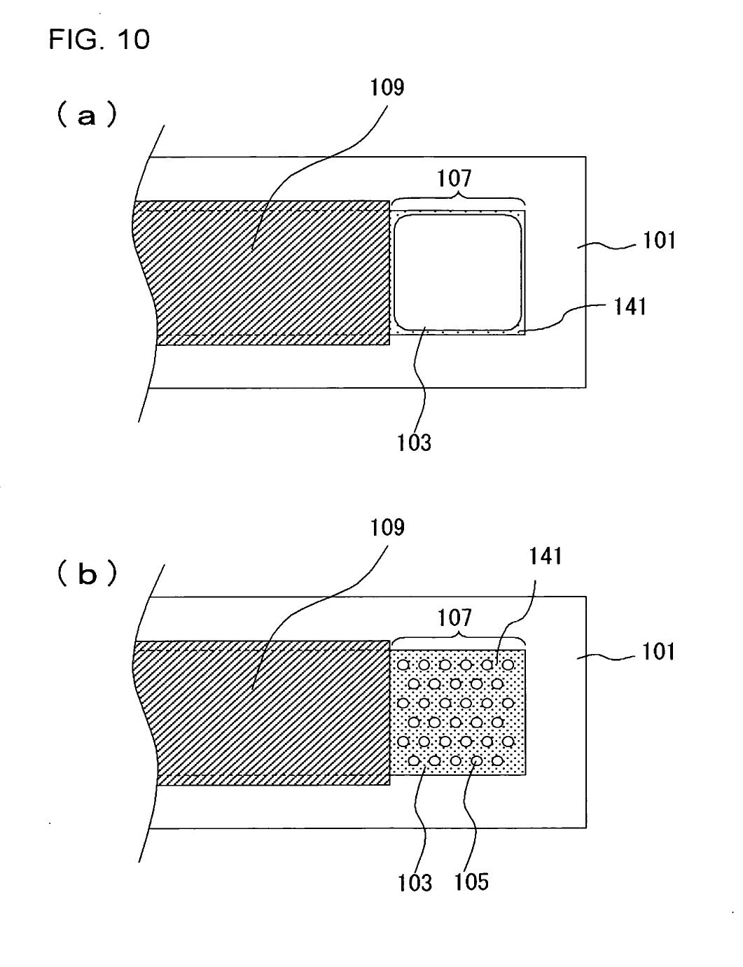

In the drying device 129, the drying area 107 comprises many pillars 105. Thus, a sample liquid 141 can be charged such that it wets the whole channel wall in the drying area 107. It will be described with reference to FIG. 10. FIG. 10 illustrates a drying device 129 filled with a liquid. FIG. 10(a) illustrates a drying area 107 without pillars 105 while FIG. 10(b) illustrates a configuration according to this embodiment.

As shown in FIG. 10(a), without a pillar 105, a sample liquid 141 can wet only a part of the drying area 107 along a channel wall from the cover 109. On the other hand, in FIG. 10(b), there are provided pillars 105, whereby the sample liquid 141 is introduced from a channel 103 to a drying area 107 by capillary phenomenon and thus fills the whole drying area 107. Thus, in the configuration in FIG. 10(b), the whole upper surface of the drying area 107 can be covered by the sample liquid 141. Furthermore, the pillars 105 ensure an adequate specific surface area in a channel in the drying area 107. The drying device 129 having such a configuration exhibits a higher drying efficiency.

The drying device 129 has a configuration where a sample liquid introduced from the channel 103 to the drying area 107 by capillary phenomenon is heated by a heater 111 to efficiently evaporate a solvent. In the configuration shown in FIG. 10(b), the pillars 105 on the channel 103 in the drying area 107 increases a specific surface area of the channel in the sample drying area, that is, a surface area of the wall per a volume of the sample drying area, so that the sample can be quickly guided to the upper surface and be efficiently concentrated in the drying area 107. Then, the sample components are precipitated on the surface of the drying area 107 and dried. Since the sample liquid 141 is continuously fed from the channel 103 to the drying area 107, operation is simple. In contrast, in the configuration shown in FIG. 10(a), the sample liquid is in contact only with the bottom and the sides of the channel 103, a heating efficiency is lower than that in the configuration in FIG. 10(b).

A temperature of heating the drying area 107 by the heater 111 may be appropriately selected, depending on some factors such as properties of components in the sample liquid to be dried; for example, 50° C. to 60° C. both inclusive. Alternatively, a drying rate of the sample liquid in the drying area 107 may be 0.1 μL/min to 10 μL/min both inclusive, for example, 1 μL/min.

In the drying device 129, the lid 119 may have any shape by which the substrate 101 can be covered such that at least part of the upper part of the drying area 107 is opened. Since the channel 103 can be sealed by providing the cover 109, the sample liquid in the channel 103 can be more efficiently guided into the drying area 107. Furthermore, the size of the opening can be adjusted to control a shape of a dried sample as discussed in the sixth embodiment later.

The substrate 101 is made of silicon. The silicon surface is preferably oxidized. Thus, the substrate surface becomes hydrophilic, so that a sample channel can be suitably formed. Alternatively, the substrate 101 may be made of another material such as a glass including quartz and a plastic. Examples of a plastic include thermoplastic resins such as silicon resins, PMMA (polymethylmethacrylate), PET (polyethyleneterephthalate) and PC (polycarbonate) and thermosetting resins such as epoxy resins. Such a material can be easily shaped, resulting in reduction in a manufacturing cost for a drying device.

When using these materials, a metal film may be formed at least over the whole surface of the drying area 107. A metal film formed on the surface makes the device electro-conductive. Thus, when a sample after drying is analyzed by mass spectrometry such as MALDI-TOFMS as a whole drying device 129, a mass spectrometer may be simplified because the drying area 107 can be used as an electrode in the mass spectrometer for applying an electric potential. Furthermore, it can prevent the component of the substrate 101 from being sublimed along with a sample, to improve accuracy and sensitivity in measurement.

The substrate 101 may be made of a metal. Using a metal, an electric potential can be more stably applied by the drying area 107, when a sample after drying is analyzed by MALDI-TOFMS as a whole drying device 129.

The pillars 105 may be, for example, formed by, but not limited to, etching the substrate 101 in a predetermined pattern.

The pillars 105 in FIG. 1 is cylindrical, but they may be, in addition to a pillar or pseudo-pillar, a cone such as circular cone and elliptic cone; a prism such as trigonal prism and quadrangular prism; and pillars having another cross-sectional shape. When the pillar 105 has a cross-sectional shape other than a pseudo-circle, the pillar 105 may have an irregular side, resulting in further increasing a surface area of the side and further improving a liquid absorbing force by capillary phenomenon.

Alternatively, a slit having the cross-section in FIG. 1(a) may be employed in place of the pillar 105. When using a slit, the pillar 105 may have any of various shapes such as a striped protrusion. Again, when using a slit, the side of the slit may be irregular to further increase a surface area of the side.

In terms of the dimensions of the pillar 105, a width may be, for example, about 5 nm to 100 μm. In FIG. 1, a height is substantially equal to the depth of the channel 103. Variation in a height of the pillar 105 will be described in the forth embodiment.

A distance between adjacent pillars 105 may be, for example, 5 nm to 10 μm.

The cover 109 may be, for example, made of a material selected from those for the substrate 101. The material may or may not be the same as that for the substrate 101.

Next, there will be described a process for manufacturing a drying device 129. The channel 103 or the pillars 105 may be formed on the substrate 101 by, but not limited to, etching the substrate 101 into a predetermined pattern.

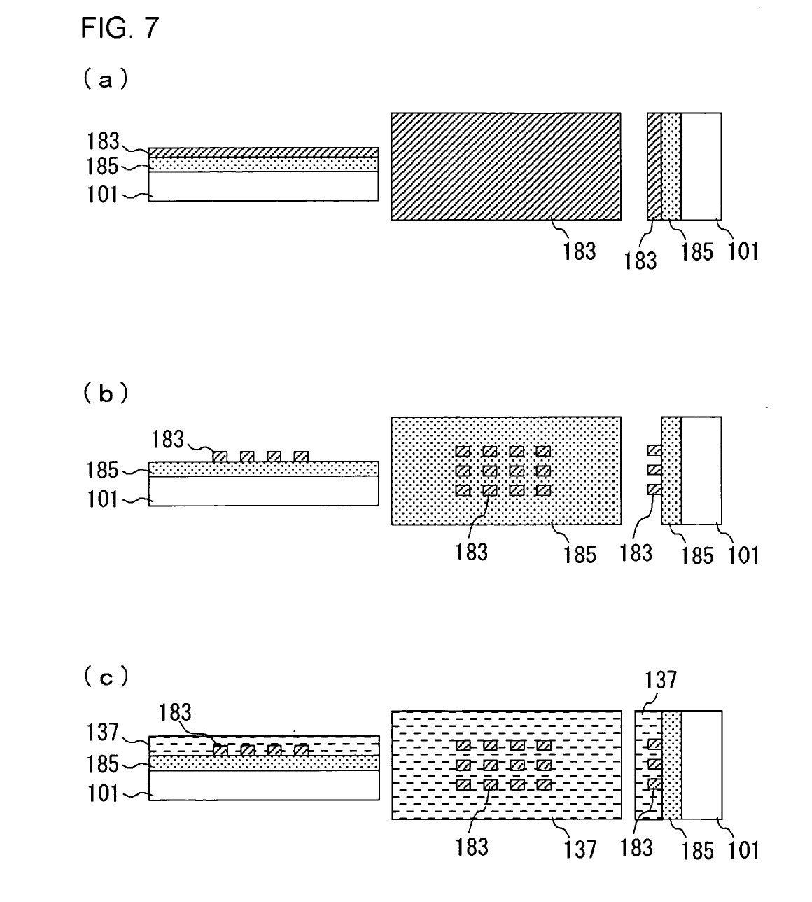

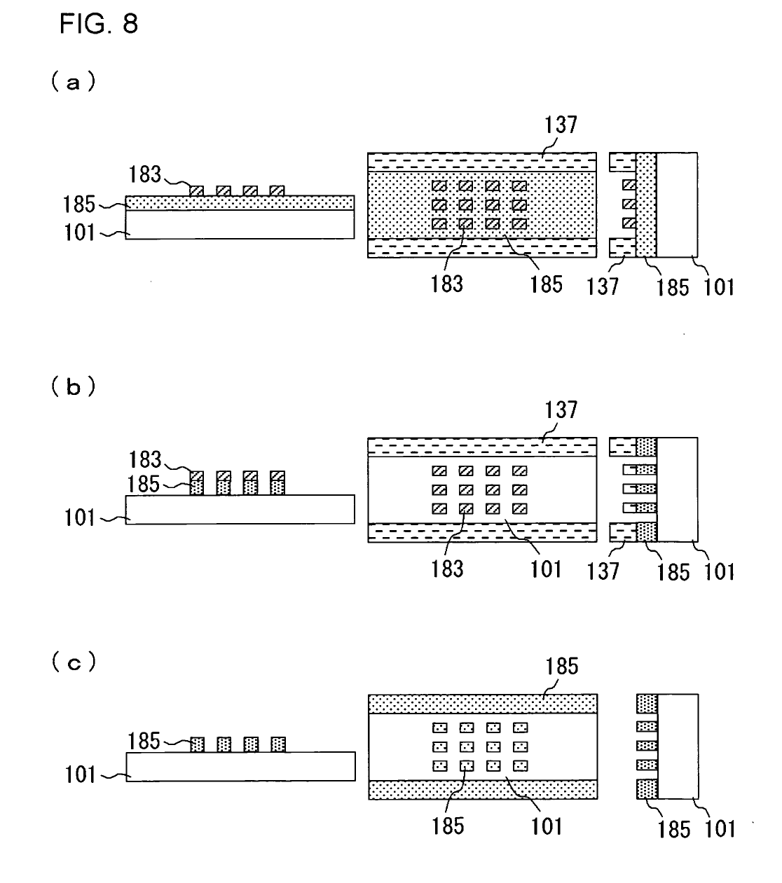

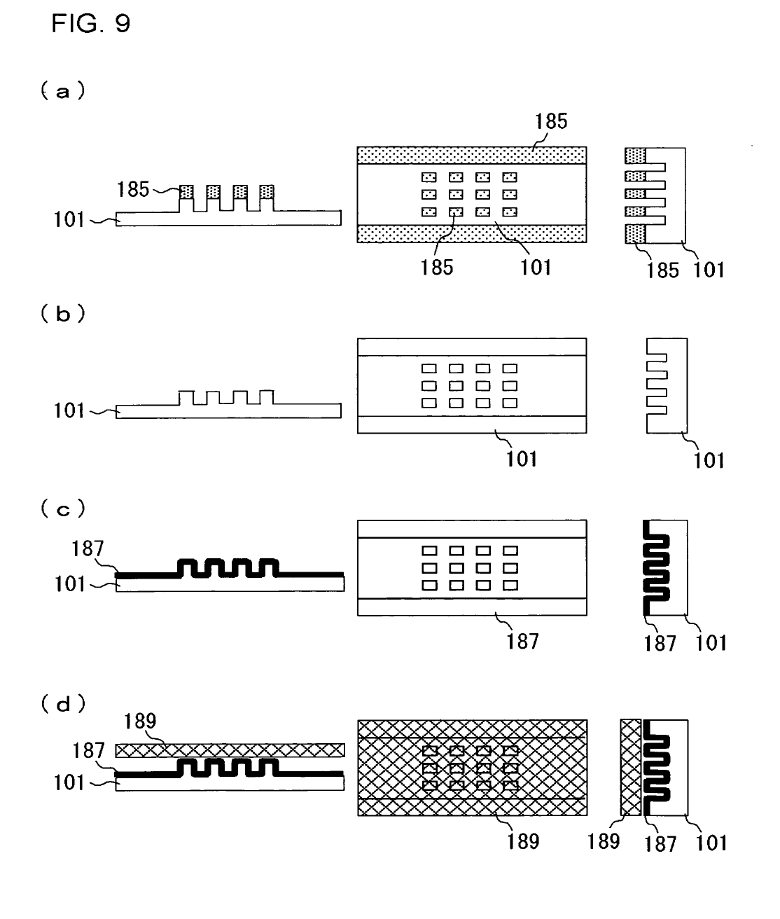

FIG. 7, FIG. 8 and FIG. 9 are process cross-sectional views illustrating an exemplary manufacturing process. In sub-figures in each figure, the middle is a top view and the right and the left are cross-sectional views. In this process, the pillars 105 are formed by the use of electron beam lithography using a calixarene as a resist for fine processing. The following is an exemplary molecular structure of a calixarene. A calixarene is used as a resist for electron beam exposure and may be suitably used as a resist for nano processing.

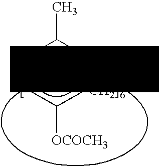

Herein, a substrate 101 is a silicon substrate with an orientation of (100). First, as shown in FIG. 7(a), on the substrate 101 are formed a silicon oxide film 185 and a calixarene electron-beam negative resist 183 in sequence. Thicknesses of the silicon oxide film 185 and the calixarene electron-beam negative resist 183 are 40 nm and 55 nm, respectively. Then, an area to be pillars 105 is exposed to an electron beam (EB). The product is developed with xylene and rinsed with isopropyl alcohol. By this step, the calixarene electron-beam negative resist 183 is patterned as shown in FIG. 7(b).

Next, a positive photoresist 137 is applied to the whole surface (FIG. 7(c)). Its thickness is 1.8 μm. Then, the product is developed by mask exposure such that the area to be the channels 103 is exposed (FIG. 8(a)).

Then, the silicon oxide film 185 is RIE-etched using a mixed gas of CF₄ and CHF₃ to a thickness of 40 nm after etching (FIG. 8(b)). After removing the resist by organic washing with a solvent mixture of acetone, an alcohol and water, the substrate is subjected to oxidation plasma treatment (FIG. 8(c)). Then, the substrate 101 is ECR-etched using HBr gas. A height of the step in the substrate 101 after etching, in other words, a height of the pillars 105, is 400 nm (FIG. 9(a)). Next, the substrate is wet etched with BHF-buffered hydrofluoric acid to remove the silicon oxide film (FIG. 9(b)). Thus, the channel 103 and the pillars 105 are formed on the substrate 101.

Herein, it is preferable to make the surface of the substrate 101 hydrophilic after the step in FIG. 9(b). By making the surface of the substrate 101 hydrophilic, a sample liquid can be smoothly guided into the channel 103 and the pillars 105. In particular, in the drying area 107 where the channel is finer by the pillars 105, hydrophilization of the channel surface is preferable because it may promote introduction of a sample liquid by capillary phenomenon to improve a drying efficiency.

After the step in FIG. 9(b), the substrate 101 is heated in a furnace to form a silicon thermal oxide film 187 (FIG. 9(c)). Herein, heating conditions are selected such that a thickness of the oxide film becomes 30 nm. Forming the silicon thermal oxide film 187 can eliminate difficulty in introducing a liquid into a separating device. Then, a cover 189 is electrostatically joined. After sealing, the drying device 129 is formed (FIG. 9(d)).

A metal film may be formed on the surface of the substrate 101. The metal film may be made of a material such as Ag, Au, Pt, Al and Ti. It may be deposited by, for example, vapor deposition or plating such as electroless plating.

When using a plastic material for the substrate 101, a known method suitable for the type of the material for the substrate 101 may be employed, including etching, press molding using a mold such as emboss molding, injection molding and photo-curing.

Again, when using a plastic material for the substrate 101, the surface of the substrate 101 is preferably hydrophilized. By hydrophilizing the surface of the substrate 101, a sample liquid can be smoothly introduced into the channel 103 and the pillars 105. In particular, in the drying area 107 where the channel 103 is finer by the pillars 105, hydrophilization of the surface of the channel 103 is preferable because it may promote introduction of a sample liquid 141 by capillary phenomenon to improve a drying efficiency.

Surface treatment for hydrophilization may be, for example, conducted by applying a coupling agent having a hydrophilic group to the side wall of the channel 103. A coupling agent having a hydrophilic group may be, for example, a silane coupling agent having an amino group, more specifically; N-β(aminoethyl)γ-aminopropylmethyldimethoxysilane, N-β(aminoethyl)γ-aminopropyltrimethoxysilane, N-β(aminoethyl)γ-aminopropyltriethoxysilane, γ-aminopropyltrimethoxysilane, γ-aminopropyltriethoxysilane and N-phenyl-γ-aminopropyltrimethoxysilane. These coupling agents may be applied by an appropriate method such as spin coating, spraying, dipping and vapor deposition.

Again, in terms of FIG. 1, a heater 111 for controlling a temperature of the drying area 107 is provided on the bottom of the substrate 101 as shown in FIG. 1(b). By disposing the heater 111 such that the end of the drying area 107 is selectively heated, a sample liquid can be surely introduced from the channel 103 to the drying area 107 so that a drying efficiency in the drying area 107 can be further improved.

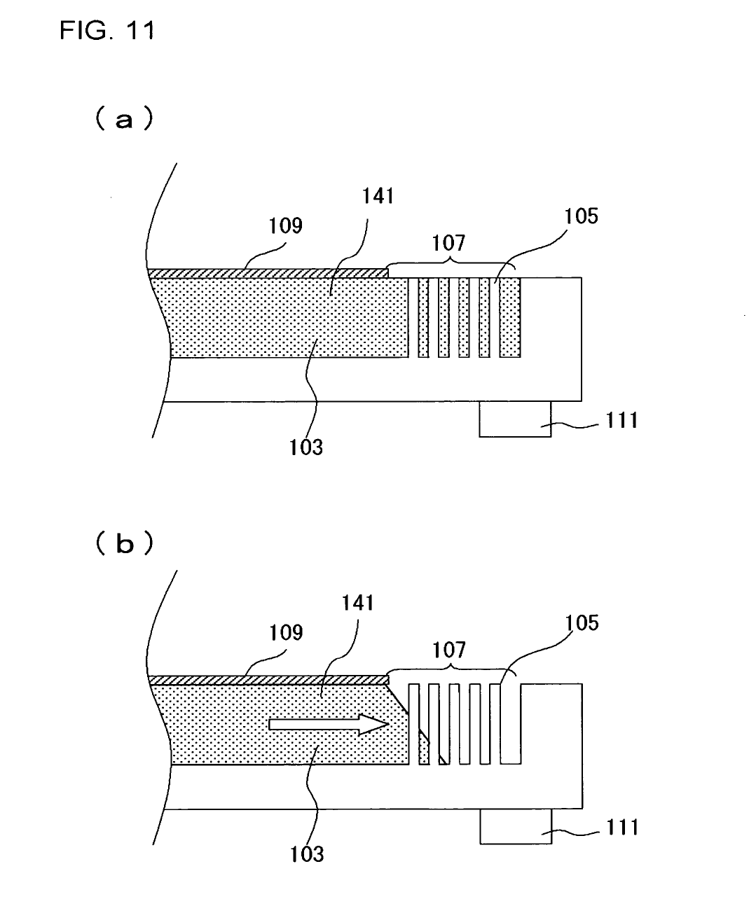

Heating of the drying area 107 is more preferably conducted in an intermittent manner. FIG. 11 illustrates a change in a sample liquid 141 during heating the drying area 107 by the heater 111. As shown in FIG. 11(a), the drying area 107 is filled with the sample liquid 141 and then heated by the heater 111. Then, drying proceeds and the amount of the sample liquid in the drying area 107 is reduced as shown in FIG. 11(b). When the heater is stopped after drying proceeds to some extent, the drying area 107 is refilled with the sample liquid (FIG. 11(a)). Then, the heater 111 is again operated to restart drying (FIG. 11(b)). The procedure may be repeated to conduct both drying and introduction of the sample liquid in a balanced manner, resulting in improvement in a drying efficiency.

### Second Embodiment

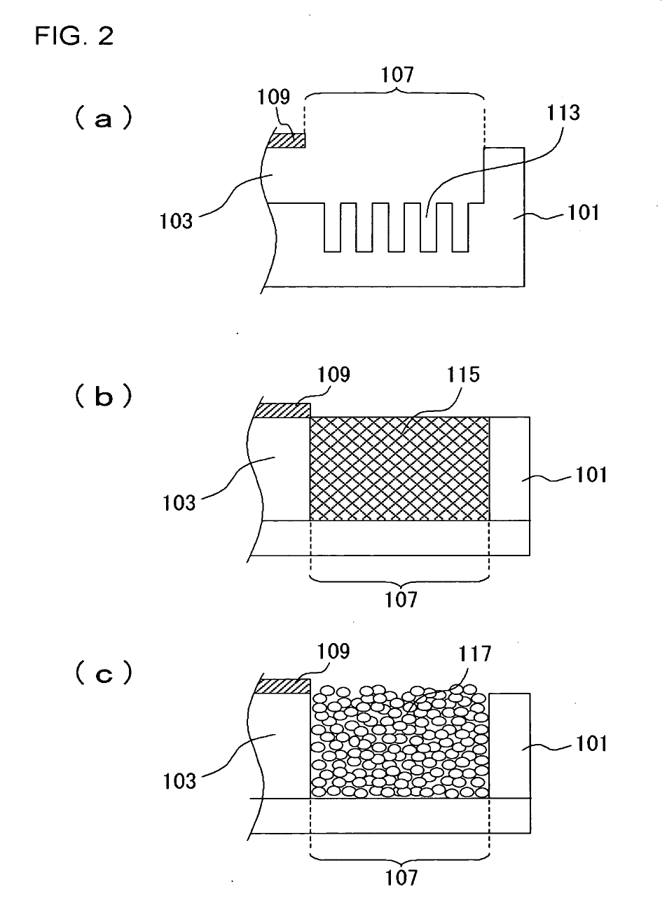

FIG. 2(b) shows a configuration of a drying device according to this embodiment. The configuration in FIG. 2(b) is as described for the drying device of the first embodiment, except that a water absorber 115 is formed in the drying area 107. The water absorber 115 has a surface having a relatively hydrophilic porous structure, and a sample solution is introduced from the channel 103 to the water absorber 115 filling the drying area 107 by capillary phenomenon.

The water absorber 115 may have any shape where a sample liquid can be introduced from the channel 103 to the drying area 107 by capillary phenomenon and evaporated on the surface. The water absorber 115 may be, for example, porous silicon or porous alumina with an etched concave structure formed by lithography.

### Third Embodiment

FIG. 2(c) shows a configuration of a drying device according to this embodiment. The configuration in FIG. 2(c) is as described for the drying device in the first embodiment, except that the drying area 107 is filled with beads 117. The beads 117 are fine particles whose surface is relatively hydrophilic. A sample solution is introduced from the channel 103 to the beads 117 filling the drying area 107 by capillary phenomenon.

The configuration in FIG. 2(c) can be provided by forming the channel 103 in the surface of the substrate 101 as described in the first embodiment and then filling one end of the surface with the beads 117. Herein, since the upper part of the channel 103 is opened, the configuration can be easily provided, because, for example, the beads 117 can be smoothly placed.

The beads 117 may be made of any material whose surface is relatively hydrophilic. In case of a highly hydrophobic material, its surface may be hydrophilized. Examples of the material include inorganic materials such as glasses and various organic and inorganic polymers. The beads 117 may have any shape which, when being placed, allows a channel for water to be ensured; for example, particles, needles or plates. For example, the beads 117 as spherical particles may have an average particle size of 10 nm to 20 μm both inclusive.

Alternatively, the drying area 107 may be filled with metal beads or semiconductor beads. Thus, an electric potential can be more surely applied by the drying area 107, when a whole drying device 129 is analyzed by mass spectrometry such as MALDI-TOFMS.

Next, there will be described a method for filling the beads 117 in the channel 103. Before joining the cover 109, a mixture of the beads 117, a binder and water is fed into the channel 103. Herein, a damming member (not shown) is formed in the channel 103 to prevent the mixture from flowing outside the area to be the drying area 107. Then, the mixture can be evaporated to dryness to form the drying area 107.

A binder may be, for example, a sol containing a water-absorbing polymer such as agarose gel and polyacrylamide gel. A sol containing such a water-absorbing polymer can be used to eliminate the need of drying because of spontaneous gelation. Alternatively, the drying area 107 may be formed by filling the channel 103 with a suspension of the beads 117 in water without a binder and drying it under the atmosphere of dry nitrogen gas or dry argon gas.

### Fourth Embodiment

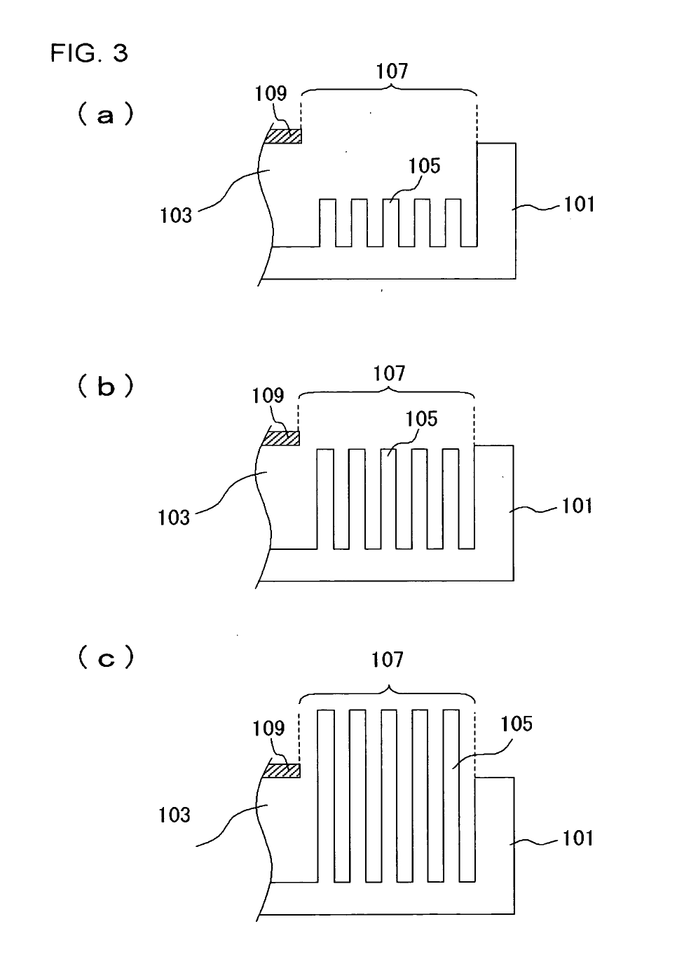

FIG. 3(c) shows a configuration of a drying device according to this embodiment. The configuration of the drying device in FIG. 3(c) is as described in the first embodiment, except that the pillars 105 protrude from the opening.

FIG. 3(a) shows a configuration where a height of the pillars 105 is smaller than the depth of the channel 103; and FIG. 3(b) shows a configuration where a height of the pillars 105 is substantially equal to the depth of the channel 103 as described in the first embodiment. Since a surface area of the pillars 105 increases in the order of FIG. 3(a), FIG. 3(b) and FIG. 3(c), a drying efficiency in the drying area 107 is improved. In the configuration in FIG. 3(c), a sample is guided to the part above the upper surface of the channel 103 by capillary phenomenon and therefore a dried sample is also deposited in the upper part of the channel 103. Thus, a dried target component can be more easily collected. Since a sample is concentrated in a direction of the height of the drying area 107, measurement can be more accurately conducted in mass spectrometry such as MALDI-TOFMS.

### Fifth Embodiment

FIG. 2(a) shows a configuration of a drying device according to this embodiment. The configuration in FIG. 2(a) is as described in the first embodiment, except that holes 113 are formed in the drying area 107. While a target component is concentrated, dried and deposited above the bottom of the channel 103 in the first to the forth embodiments, the configuration in FIG. 2(a) is different in that a target component is concentrated, dried and deposited at the height near the bottom of the channel 103. In the configuration where the holes 113 are formed in the drying area 107, a surface area of the channel in the drying area 107 is also increased by the holes 113, allowing a sample liquid to be efficiently concentrated and dried.

The configuration in FIG. 2(a) can be provided as described in the first embodiment, for example, by etching.

Although the holes 113 have a circular cross section in FIG. 2(a), it may have another shape such as a polygon. Furthermore, the side of the hole 113 may be made convexoconcave to further increase a surface area of the side of the hole 113 as described in the first embodiment and to further increase a liquid absorbing force by capillary decreasing.

The holes 113 may be a slit having the cross section in FIG. 2(a). When using a slit, a surface area of the side maybe also further increased by making the slit side irregular.

The hole 113 may have, for example, a width of 10 nm to 20 μm both inclusive and a depth of 10 nm to 20 μm both inclusive.

### Sixth Embodiment

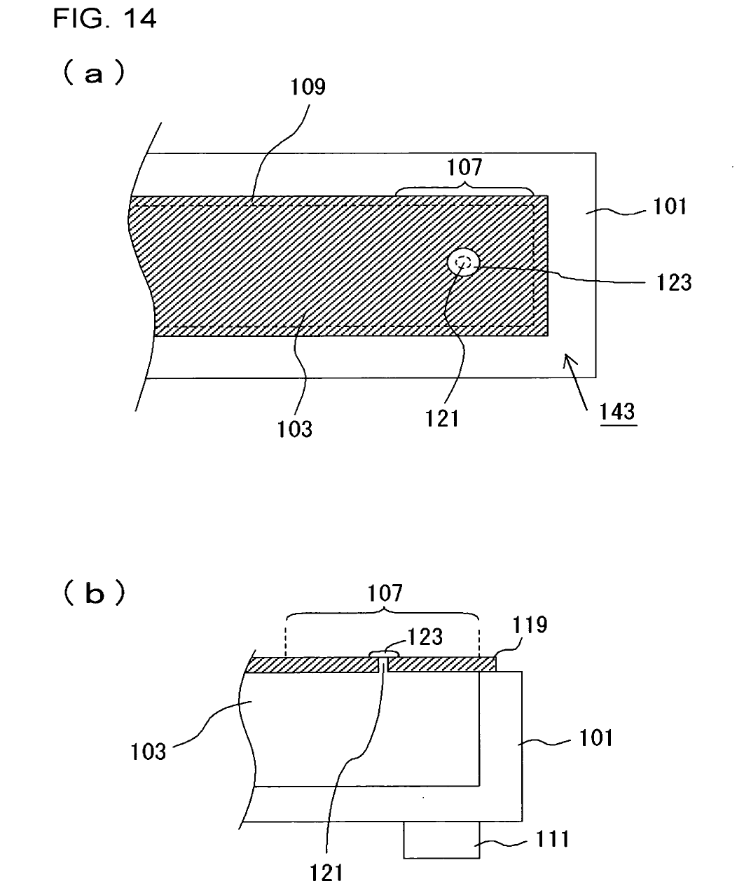

This embodiment relates to a drying device where a sample is dried using an opening formed in the upper part of a channel as a fine channel to deposit a dried sample on the upper surface of a lid. FIG. 14 shows a configuration of a drying device according to this embodiment. FIG. 14(a) is a top view of a drying device 143 and FIG. 14(b) is a cross-sectional view of the periphery of the drying area 107 in FIG. 14(a). The drying device 143 comprises a lid 119 covering the whole surface of the channel 103 including the drying area 107. In the lid 119, an opening 121 is formed as a fine channel, through which the channel 103 is communicated with the outside air. Thus, a liquid in the sample introduced from the channel 103 to the drying area 107 is guided to the opening 121 by capillary phenomenon and then evaporated.

The lid 119 formed allows a dried sample 123 to be selectively deposited near the opening 121 in the upper surface of the lid 119. Furthermore, the size of the opening 121 can be adjusted to adjust a surface area of the dried sample 123. One opening 121 may be formed in the lid 119 as shown in FIG. 14, or alternatively a plurality of openings 121 may be formed.

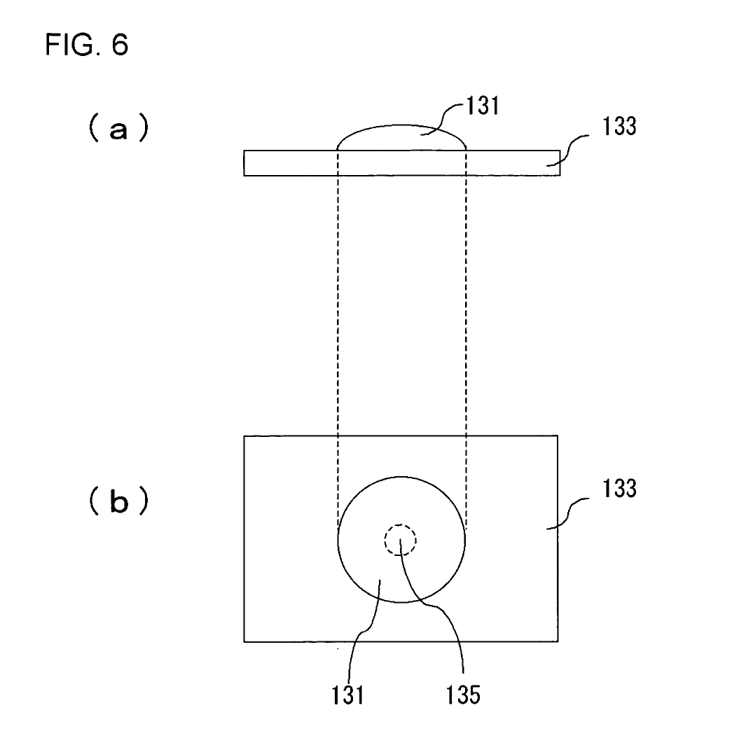

When forming the opening 121 in the lid 119 and, for example, the drying device 143 and the dried sample 123 are analyzed by MALDI-TOFMS measurement, the size of the dried sample 123 may be adjusted to be substantially equal to the maximum spot size 135 of a laser beam described above in FIG. 6. Thus, a concentration of the dried sample 123 can be increased in the laser-beam irradiation site to improve accuracy and sensitivity in measurement.

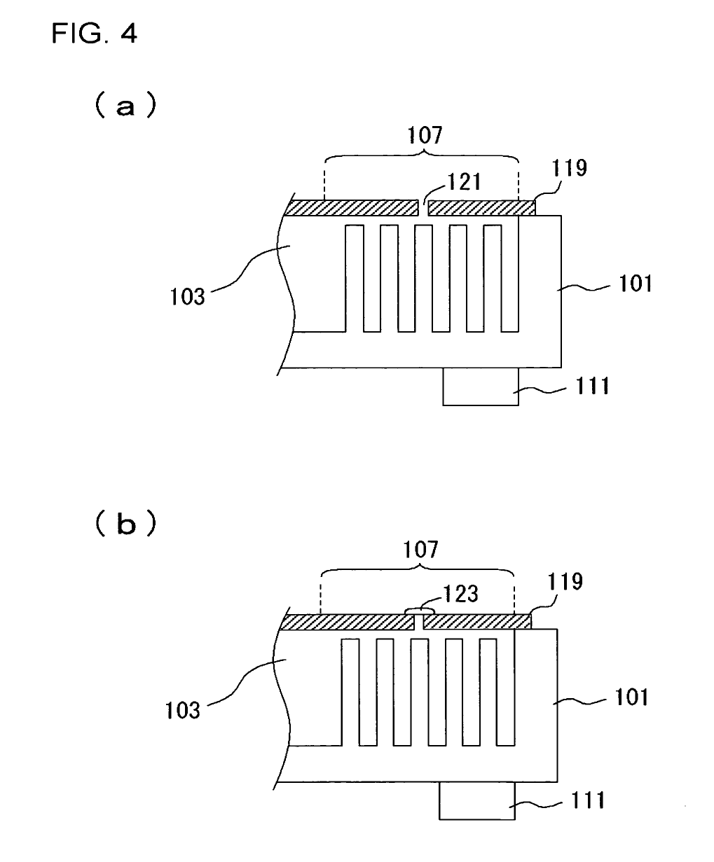

In the drying device 143, the pillars 105 may be formed in the drying area 107 as described in the first embodiment, which is shown in FIG. 4(a). Thus, the channel becomes finer in the drying area 107, so that drying can be more efficiently conducted and the dried sample 123 can be deposited near the opening 121 in the upper surface of the lid 119 (FIG. 4(b)).

### Seventh Embodiment

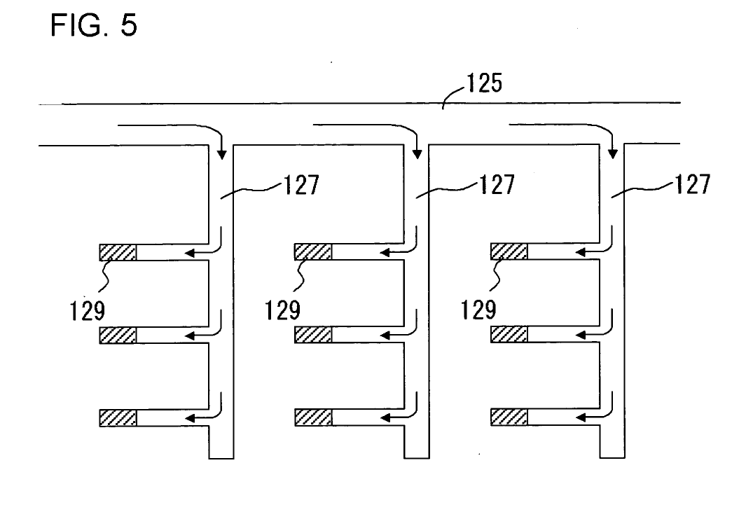

This embodiment relates to a microchip comprising a plurality of the drying devices 127 described in the first embodiment. FIG. 5 schematically shows a configuration of the microchip according to this embodiment.

The microchip in FIG. 5 comprises a main channel 125 and a plurality of side channels 127 branched from the main channel 125 on a substrate (not shown). Each side channel 127 is communicated with a plurality of drying devices 129.

Using microchip in FIG. 5, a sample liquid containing multiple components can be purified and separated into the components, which can be finally concentrated, dried and collected in the drying device 129.

For example, when a current is applied to the main channel 125 and the side channels 127 are filled with a gel and the like to conduct separation similar to two-dimensional electrophoresis in the microchip, the system can be designed such that a drying device 129 can be communicated with a site corresponding to a band for each component separated in the side channel 127, to independently collect each component from the sample.

Specifically, for separating water-soluble proteins in blood, a separating device may be placed upstream of the main channel 125 to remove insoluble components. Furthermore, a separation mechanism which can remove low molecular weight components in a plasma by permeation is employed to allow only high molecular weight fractions to remain in the main channel 125. The remaining high molecular weight fractions are two-dimensionally separated in the main channel 125 and the side channels 127 as described above, before introducing them into the drying device 129. Herein, the drying device 129 can be placed in the main channel 125 upstream of the side channels 127 to concentrate the high molecular weight fractions to some degree before separation and thus to further improve a separation efficiency.

Although the drying device 129 is used in FIG. 5, a drying device having another configuration according to this embodiment may be, of course, employed.

### Eighth Embodiment

In this embodiment, the drying device 129 according to the first embodiment is used as a substrate for MALDI-TOFMS. There will be described, as an example, preparation and measurement of a protein sample for MALDI-TOFMS using the drying device 129.

For obtaining detailed data of a protein to be measured by MALDI-TOFMS, its molecular weight must be reduced to about 1000 Da. Thus, after molecular weight reduction, the sample is mixed with a matrix solution and dried in the drying device 129 to provide a dried sample.

When the target protein has an intramolecular disulfide bond, the sample is subjected to reduction in a solvent such as acetonitrile containing a reducing agent such as DTT (dithiothreitol). Thus, a next decomposition reaction can efficiently proceed. It is preferable that after reduction, a thiol group is protected by, for example, alkylation to prevent re-oxidation.

Next, the reduced protein molecule is subjected to molecular weight reduction using a protein hydrolase such as trypsin. Since molecular weight reduction is conducted in a buffer such as a phosphate buffer, desalting and removal of the high molecular weight fraction, that is, trypsin, must be conducted after the reaction. The material obtained is mixed with a MALDI-TOFMS matrix and introduced from the channel 103 to the drying area 107.

A temperature in the drying area 107 is controlled by the heater 111 for concentrating and drying the sample to precipitate a mixture of the matrix and the decomposed protein in the upper part of the pillars 105. Herein, as described above in the first embodiment, on-off of the heater 111 can be repeated for repeating drying and introduction of the sample solution to efficiently conduct drying.

After drying, the sample as a whole drying device 129 is set in a MALDI-TOFMS apparatus. Then, while applying a voltage using the drying device 129 as an electrode, for example, it is irradiated with a nitrogen laser beam at 337 nm for MALDI-TOFMS analysis.

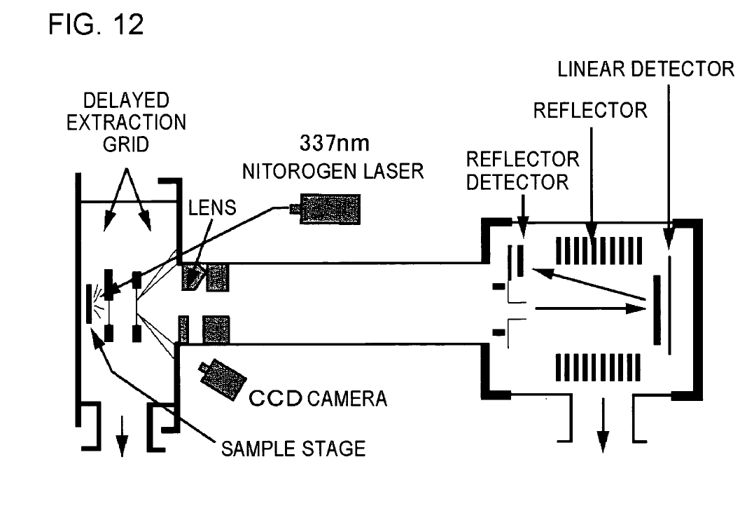

There will be briefly described a mass spectrometer used in this embodiment. FIG. 12 schematically illustrates a configuration of the mass spectrometer. In FIG. 12, the dried sample is set on a sample stage. Then, the dried sample is irradiated with a nitrogen gas laser at a wavelength of 337 nm in vacuo, to vaporize the dried sample together with the matrix. By applying a voltage using the sample stage as an electrode, the vaporized sample travels in the vacuum atmosphere and detected by a detection unit comprising a reflector detector, a reflector and a linear detector.

Therefore, after fully drying the liquid in the drying device 129, the drying device 129 can be placed in a vacuum chamber in the MALDI-TOFMS apparatus and used as a sample stage for MALDI-TOFMS. Since a metal film is formed on the surface of the drying area 107 and is connectable to an external power source, a potential can be applied to it as a sample stage.

Thus, using the drying device 129, the dried sample as the whole drying device 129 can be used in MALDI-TOFMS. Furthermore, for example, a sample separating device may be formed upstream of the channel 103 to be able to conduct extraction, drying and structural analysis of a target component on a single drying device 129. Such a drying device 129 may be useful in, for example, proteome analysis.

Herein, since the drying device 129 is used as a chip for MALDI-TOFMS, a step of washing an electrode plate for each sample can be eliminated, resulting in improvement in operational convenience and in measurement accuracy.

A MALDI-TOFMS matrix may be appropriately selected, depending on a material to be measured. Examples of a matrix which can be used include sinapic acid, α-CHCA (α-cyano-4-hydroxycinnamic acid), 2,5-DHB (2,5-dihydroxybenzoic acid), a mixture of 2,5-DHB and DHBs (5-methoxysalicylic acid), HABA (2-(4-hydroxyphenylazo)benzoic acid), 3-HPA (3-hydroxypicolinic acid), dithranol, THAP (2,4,6-trihydroxyacetophenone), IAA (trans-3-indoleacrylic acid), picolinic acid and nicotinic acid.

This embodiment has been described in terms of the drying device 129 described in the first embodiment, but drying devices in other embodiments can be, of course, used.

Alternatively, a fine-structure in the upper surface of the drying area 107 comprising the pillars 105, the holes 113, the water absorber 115 or the beads 117 and so forth in any of the drying devices described in the above embodiments may be adjusted to allow a sample to be more efficiently ionized without a matrix. Such a configuration can eliminate the need for mixing a protein solution with a matrix solution, so that, for example, each fraction collected in the seventh embodiment together with the drying device 129 may be used for MALDI-TOFMS.

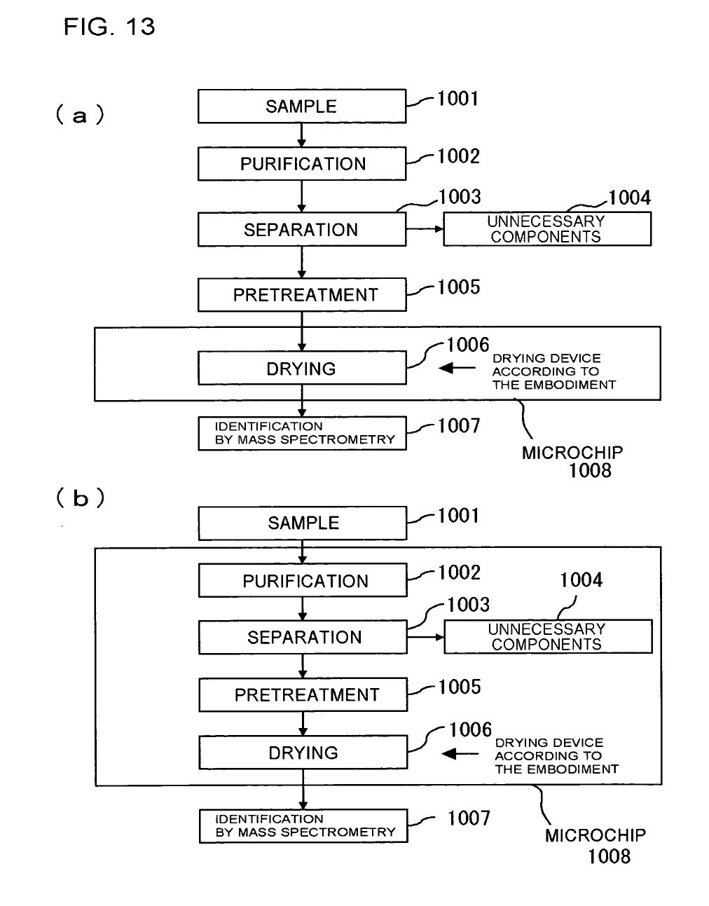

FIG. 13 is a block diagram of a mass spectrometry system comprising a drying device according to this embodiment. As shown in FIG. 13(a), the system comprises means to perform each step of; purification 1002 for removing impurities in a sample 1001 to some degree; separation means 1003 for removing unnecessary components 1004; pretreatment 1005 for a separated sample; drying 1006 for a sample after pretreatment; and identification 1007 by mass spectrometry.

Drying by the drying device in this embodiment corresponds to the drying step 1006, which is conducted on a microchip 1008. The step of purification 1002 may be conducted, for example, using a separating portion for separating only giant components such as blood cells. The step of separation 1003 may be conducted by a procedure such as two-dimensional electrophoresis, capillary electrophoresis and affinity chromatography and so on. In the step of pretreatment 1005, molecular weight reduction using, for example, trypsin described above and mixing with a matrix are conducted.

Since the drying device according to this embodiment comprises a channel, the steps of purification 1002 to drying 1006 may be conducted on a piece of microchip 1008 as shown in FIG. 13(b). A sample may be continuously processed on the microchip 1008 to efficiently and reliably identify a trace amount of component in a loss-reducing manner.

Thus, of the sample processing steps shown in FIG. 13, all or those appropriately selected can be conducted on the microchip 1008.

This invention has been described with reference to some embodiments. It will be understood by the skilled in the art that these embodiments are only illustrative and that there may be many variations for a combination of the components and the manufacturing process, which are encompassed by the present invention.

### EXAMPLE

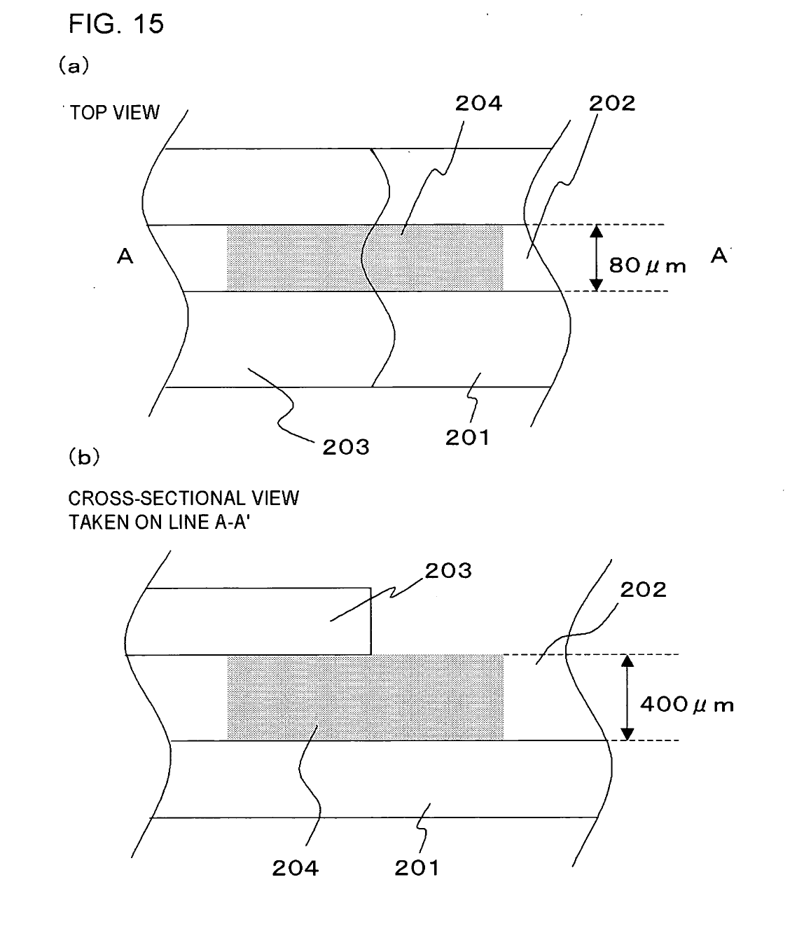

In this example, a drying device comprising the pillars described above with reference to FIG. 1 was fabricated on a substrate and evaluated. FIG. 15 schematically shows the drying device. FIG. 15(a) is a top view of the drying device and FIG. 15(b) is a cross-sectional view taken on line A-A′ of FIG. 15(a).

In FIG. 15, a channel 202 is formed on a substrate 201 and a part of its upper surface is covered by a glass lid 203. The part with the glass lid 203 is upstream while that without the lid is downstream. A drying area 204 is formed in an outlet area in the channel 202, in other words, the area upstream and downstream of the end of the glass lid 203. The drying area 204 comprises columnar structures 205.

In this example, the channel 202 and the columnar structure 205 were formed by the processing method described in the first embodiment. Silicon was used as a substrate. The channel 202 had a width of 80 μm and a depth of 400 nm.

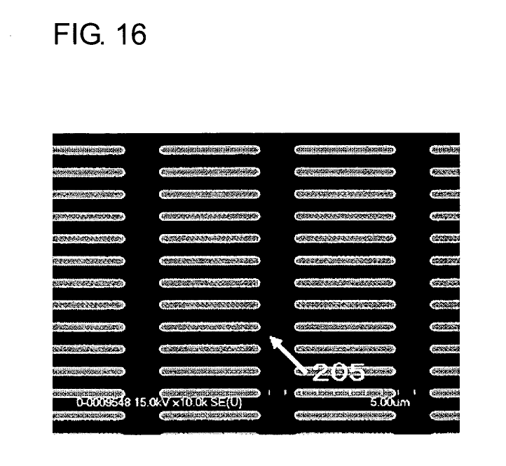

FIG. 16 shows a scanning electron microgram of the columnar structure 205 formed in the outlet area in the channel 202. In FIG. 16 and FIGS. 17 and 18 described later, the lower direction from the paper is upstream and the upper direction is downstream. As shown in FIG. 16, the drying area 204 of the drying device of this example comprises a plurality of strip-type columnar structures 205 with a width of 3 μm aligned with an equal pitch of about 1 μm in a longitudinal direction of the columnar structures 205 (a transverse direction in this figure), and multiple rows of the columnar structures 205 are disposed with an equal pitch of 700 nm in a lateral direction of the columnar structures 205 (a vertical direction in this figure). A height of the columnar structures 205 is 400 nm.

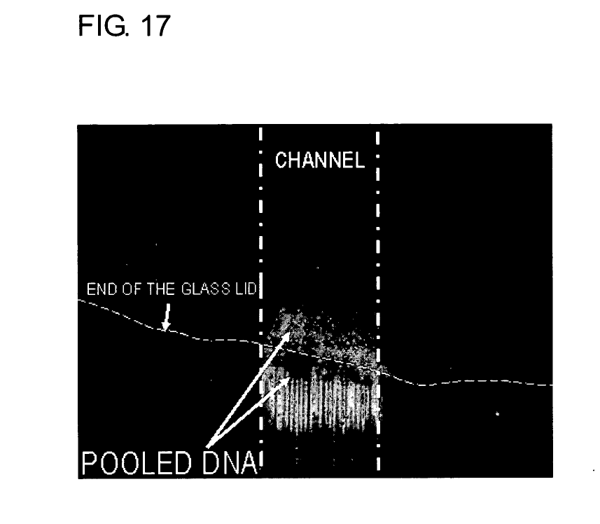

The drying device manufactured in this example was used to continuously conduct drying and mass spectrometry of a DNA as described below. The channel 202 was filled with a solution containing a DNA (100 bp) stained with a fluorescent dye from the upstream of the channel 202. Then, the outlet area in the channel 202 was observed by fluorescence microscopy. FIG. 17 shows a fluorescence microgram of the area near the columnar structure 205 formed in the drying area 204 in the outlet area in the channel 202. FIG. 17 shows that the DNA brightly highlighted by the fluorescence microscopy is exuded as a 60 μm band downstream of the glass lid 203. Thus, using the drying device of this example, the sample could be stably introduced into the drying area 204 and easily dried as described with reference to FIG. 10(b).

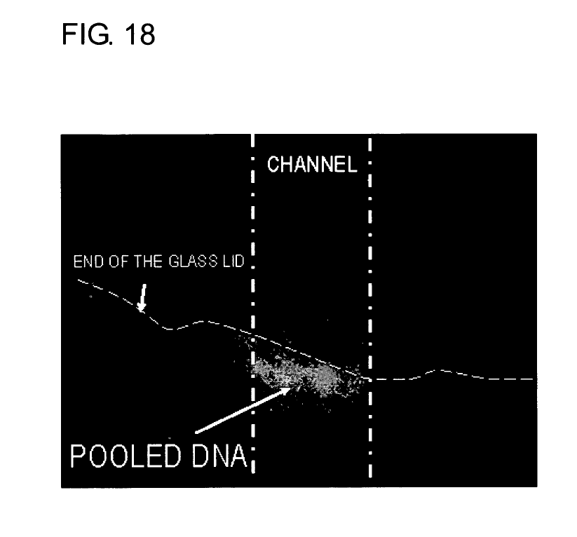

For comparison, a drying device without columnar structures 205 was manufactured in a similar manner. FIG. 18 shows a fluorescence microgram for the device without columnar structures 205 in the outlet area in the channel, in which DNA is not exuded outside of the glass lid 203. In the chip used in this example without columnar structures 205 where the depth of the channel 202 is 400 nm, it can be seen that a wetting degree described with reference to FIG. 10(a) is further reduced so that the drying area 204 is not wetted even in the area from the edge of the glass lid 203 to the wall surface of the channel 202.

Then, the DNA dried using the drying device in FIG. 17 was analyzed by mass spectrometry. Specifically, the substrate 201 was sonicated on an ultrasonic vibrator to fragmentate the DNA and then the solvent was air dried. Then, a several microliters of matrix was added dropwise to the dried DNA exuded in the outlet area in the channel 202 and the product was analyzed by MALDI-TOFMS. As a result, the analysis results from the DNA could be obtained.

As described above, in this example, the drying area 204 comprising a plurality of columnar structures 205 at the end of the channel 202 whose upper surface is at least partly opened was formed, so that the DNA could be moved to the drying area 204 and then easily dried. Furthermore, the drying device could be used as a sample stage for a mass spectrometer and mass spectrometry could be conducted without removing the dried sample from the drying device.

1. A sample drying device comprising:
a channel for a sample flowing in said channel; and
a sample drying area having an opening communicating with said channel,
wherein said sample drying area comprises a fine channel narrower than said channel.

2. A sample drying device comprising:
a main channel for a sample flowing in said main channel;
a plurality of side channels branched from said main channel; and
a sample drying area communicating with said side channels, wherein said sample drying area has a fine channel narrower than said side channels.

3. The sample drying device as claimed in claim 2,
wherein said sample contains multiple components and said main channel comprises a separating portion to separate said components.

4. The sample drying device as claimed in any of claims 1 to 3,
wherein said sample drying area comprises a plurality of protrusions separated each other.

5. The sample drying device as claimed in claim 4,
wherein said drying area has a shape so that the top of said sample drying area projects from said opening.

6. The sample drying device as claimed in any of claims 1 to 3,
wherein said sample drying area is filled with multiple particles.

7. The sample drying device as claimed in any of claims 1 to 3,
wherein said sample drying area is filled with a porous material.

8. The sample drying device as claimed in any of claims 1 to 3,
wherein said sample drying area has a lid comprising a fine channel communicating with said outside of said sample drying device.

9. The sample drying device as claimed in any of claims 1 to 3,
wherein said sample drying device comprises a temperature controller for controlling a temperature of said sample drying area.

10. A mass spectrometer comprising a sample drying area included in said sample drying device as claimed in any of claims 1 to 3, as a sample holder.

11. A mass spectrometry system comprising:
separating unit separating components in a biological sample by their molecular sizes and properties;
pretreatment unit pretreating said sample separated by said separating unit including enzymatic digestion;
drying unit drying the pretreated sample components; and
mass spectrometry unit conducting mass spectrometry for the dried sample,
where in said drying unit comprises said sample drying device as claimed in any of claims 1 to 3.
